(19) United States
(12) Patent Application Publication
(10) Pub. No.: US 2026/0126286 A1
(43) Pub. Date: May 7, 2026

(54) LASER TRACKING INTERFEROMETRIC SPATIAL COORDINATE MEASUREMENT SYSTEM AND METHOD BASED ON DUAL ELECTRO-OPTICAL FREQUENCY COMB

(71) Applicant: ZHEJIANG SCI-TECH UNIVERSITY, Zhejiang (CN)

(72) Inventors: Benyong CHEN, Zhejiang (CN); Liping YAN, Zhejiang (CN); Jiandong XIE, Zhejiang (CN); Yingtian LOU, Zhejiang (CN)

(73) Assignee: ZHEJIANG SCI-TECH UNIVERSITY, Zhejiang (CN)

(21) Appl. No.: 19/433,975

(22) Filed: Dec. 29, 2025

Related U.S. Application Data
(63) Continuation of application No. PCT/CN2025/087534, filed on Apr. 7, 2025.

(30) Foreign Application Priority Data
May 21, 2024 (CN) 202410631580.8

(51) Int. Cl. G01B 11/24; G01B 9/02; G01B 9/02001; G01B 9/02055

(52) U.S. Cl. CPC G01B 11/2441; G01B 9/02008; G01B 9/02067; G01B 9/02083

(57) ABSTRACT

The disclosure discloses a laser tracking interferometric spatial coordinate measurement system and a method thereof based on dual electro-optical frequency comb. Multi-target mirrors are identified, guiding a rotating mirror to direct a laser beam to each target. A tracking error of the laser beam deviating from the target center is obtained for closed-loop tracking control. A single-frequency laser traceable to gas absorption peaks is outputted. By turning the electro-optic phase modulation drive signal on or off, either dual electro-optic frequency comb or dual-frequency continuous-wave laser is outputted. Under tracking mode, the absolute distance and relative displacement of the target mirror are measured using the two light sources respectively, obtaining the real-time distance between the target mirror and an origin through data fusion. The azimuth and elevation angles are acquired in real time. Tracking control and coordinate calculation are performed, obtaining 3D spatial coordinates of all target mirrors.

### CROSS-REFERENCE TO RELATED APPLICATION

This application is a continuation of international PCT application serial no. PCT/CN2025/087534, filed on April 7, 2025, which claims the priority benefit of China application no. 202410631580.8, filed on May 21, 2024. The entirety of each of the above–mentioned patent applications is hereby incorporated by reference herein and made a part of this specification.

### TECHNICAL FIELD

The disclosure belongs to the field of laser tracking measurement technology, and more particularly to a laser tracking interferometric spatial coordinate measurement system and a method thereof based on a dual electro-optical frequency comb.

### Related Art

Laser tracking interferometric measurement technology is widely applied in fields such as large-scale high-end equipment assembly and industrial robot positioning accuracy calibration due to its advantages of large measurement range, high precision, and fast speed.

Distance measurement is the core technology of laser tracking interferometric measurement. Existing laser tracking interferometric measurement methods typically adopt a combination of absolute distance measurement (ADM) and relative displacement measurement (RDM) for ranging measurement. The ADM method may obtain absolute distance and may resume measurement after beam interruption, but is only suitable for static measurement. The RDM method may achieve high-speed displacement measurement, but the measurement result is displacement increment, and beam interruption will cause measurement failure. The combined measurement approach combines the advantages of both measurement methods, but requires combining the measurement light of two measurement units into one laser beam before measurement. When mechanical components used to fix optical elements slowly deform over time, the combined light beam will bifurcate, thereby introducing measurement errors. On the other hand, the two ranging units have different distance reference zero points, which may introduce additional drift errors and increase system complexity and cost.

Therefore, the prior art lacks the use of the same ranging unit to construct both ADM and RDM ranging modes to achieve high-precision absolute distance measurement, which is a technical problem that has not been solved in the field of laser tracking interferometric measurement.

### SUMMARY OF INVENTION

To solve the problems existing in the background technology, the disclosure provides a laser tracking interferometric spatial coordinate measurement system and a method thereof based on a dual electro-optical frequency comb, adopting a single ranging module based on the dual electro-optical frequency comb to achieve both ADM and RDM ranging functions.

The technical solution adopted by the disclosure to solve the technical problems is the following.

I. A laser tracking interferometric spatial coordinate measurement system based on a dual electro-optical frequency comb, divided into three parts: a precision optical tracking unit, a ranging unit based on a dual electro-optical frequency comb, and an electrical control unit. A part of the precision optical tracking unit is mounted on the frame body, and another part is mounted on an object under test or a space under test. The ranging unit is mounted within the frame body. The electrical control unit is electrically connected to the precision optical tracking unit and the ranging unit respectively. The electrical control unit controls the ranging unit based on the dual electro-optical frequency comb to emit a dual electro-optical frequency comb beam that is reflected and adjusted by the precision optical tracking unit to be incident on the object under test or the space under test and then received to perform spatial coordinate measurement of the object under test or the space under test.

The precision optical tracking unit mainly includes a target mirror assembly, a rotating mirror, a pitch torque motor, a vision module, a pitch angle measurement module, an azimuth torque motor, and an azimuth angle measurement module. The target mirror assembly is arranged on the object under test or in the space under test. The azimuth torque motor is mounted on an upper end of the frame body, and a horizontal and parallel rotating mirror shaft and vision shaft are mounted on a rotating end of the azimuth torque motor through a bracket, while the rotating end of the azimuth torque motor is provided with an azimuth angle measurement module for detecting a rotation angle. An end of the rotating mirror shaft is coaxially and fixedly connected to the rotating end of the pitch torque motor, another end of the rotating mirror shaft is connected to a pitch angle measurement module for measuring the rotation angle of the rotating mirror shaft, and a rotating mirror is fixedly mounted on the rotating mirror. The vision shaft is rotatably mounted on the bracket through a gear assembly, and a vision module is fixedly mounted on the vision shaft.

The ranging unit based on the dual electro-optical frequency comb includes a beam adjustment module, a laser tracking interferometric ranging module, a light source modulation module, and a light source module arranged sequentially from a bottom to a top.

The light source module outputs a single-frequency laser traceable to a gas absorption peak. The single-frequency laser is transmitted through polarization-maintaining fiber to the light source modulation module for electro-optical phase modulation to generate the dual electro-optical frequency comb. The dual electro-optical frequency comb is transmitted to the laser tracking interferometric ranging module. The laser tracking interferometric ranging module outputs measurement light transmitted to the beam adjustment module. The beam adjustment module expands and collimates the measurement light, then adjusts it through translation and deflection control, so that the measurement light is incident to a center of the rotating mirror, reflected by the rotating mirror and incident on the target mirror assembly of the object under test or the space under test, and returns to the laser tracking interferometric ranging module after being reflected by the target mirror assembly.

The pitch torque motor, the vision module, the pitch angle measurement module, the azimuth torque motor, and the azimuth angle measurement module within the precision optical tracking unit are electrically connected through a wire and a coaxial conductive ring disposed at the upper end of the frame body.

The electrical control unit mainly includes a power supply module, a tracking control and signal processing module, and a computer. The tracking control and signal processing module is electrically connected to the computer. The power supply module is connected to the tracking control and signal processing module for power supply. The tracking control and signal processing module is electrically connected to the precision optical tracking unit and the ranging unit respectively.

The system further includes an environmental monitoring sensor. The environmental monitoring sensor is electrically connected to the tracking control and signal processing module of the electrical control unit. The environmental monitoring sensor is configured to measure air temperature, humidity, and atmospheric pressure parameters and wirelessly transmit the same to the tracking control and signal processing module.

The tracking control and signal processing module of the electrical control unit processes and outputs a closed-loop control signal based on a target mirror information in an image obtained by the vision module and the tracking error signals obtained by the laser tracking interferometric ranging module, thereby controlling the azimuth torque motor and pitch torque motor to jointly rotate the rotating mirror to track the target mirror; simultaneously, the pitch angle and azimuth angle information of the target mirror under tracking status are obtained in real time through the azimuth angle measurement module and pitch angle measurement module, and combined with the distance information obtained by the laser tracking interferometric ranging module, synchronous matching of the angle information and the distance information is performed. After processing by the computer, a three-dimensional coordinate of each target mirror in the target mirror assembly is obtained.

The laser tracking interferometric ranging module includes a laser diode, a fiber polarization-maintaining combiner, a first collimator, a first polarizing beamsplitter, a reference corner cube prism, a filter, a first quarter-wave plate, a second quarter-wave plate, a second collimator, a color separator, a second polarizing beamsplitter, a first photodetector, a second photodetector, a two-dimensional position detector, and a right-angle mirror mounted within a shielding enclosure. The ranging unit emits measurement light from the dual electro-optical frequency comb and indication light from the laser diode together incident to the polarization-maintaining fiber combiner to combine and form a first combined beam. The first combined beam is then expanded and collimated by the first collimator and incident to the first polarizing beamsplitter for a first transmission and reflection. The first combined beam after the first reflection by the first polarizing beamsplitter is sequentially reflected by the first quarter-wave plate, the filter, and the reference corner cube prism, and then returns along an original path to the first polarizing beamsplitter for a second transmission. The first combined beam after the first transmission by the first polarizing beamsplitter is sequentially reflected by the second quarter-wave plate and the right-angle mirror, and then exits through a window plate on the shielding enclosure to the beam adjustment module. After adjustment by the beam adjustment module, the first combined beam is incident to the target mirror assembly, and after reflection by the target mirror assembly, the first combined beam returns along the original path to the first polarizing beamsplitter for a second reflection.

Retroreflected beams returning to the first polarizing beamsplitter undergo the second reflection and the second transmission, and after combining, form a second combined beam. The second combined beam is then incident on the color separator where transmission and reflection occur. The beam reflected by the color separator is incident on the two-dimensional position detector and received to obtain a tracking error signal. The beam transmitted by the color separator is then incident on the second polarizing beamsplitter where reflection and transmission occur respectively. The ranging unit emits reference light from the dual electro-optical frequency comb, which undergoes beam expansion and collimation through the second collimator before being incident on the second polarizing beamsplitter where reflection and transmission occur. The reference light beam reflected by the second polarizing beamsplitter and the second combined beam transmitted by the second polarizing beamsplitter are incident together on the first photodetector and received to obtain a reference interference signal. The reference light beam transmitted by the second polarizing beamsplitter and the second combined beam reflected by the second polarizing beamsplitter are incident together on the second photodetector and received to obtain a measurement interference signal.

The tracking control and signal processing module includes an image processing module, a tracking error signal preprocessing module, an angle decoding module, a tracking control module, a motor driver, a synchronization module and a signal processing module, the signal processing module includes an absolute distance measurement signal processing module, an air refractive index calculation module, a relative displacement measurement signal processing module and a distance fusion module.

Input terminals of the image processing module, the tracking error signal preprocessing module, and the angle decoding module are electrically connected to the vision module, the two-dimensional position detector, and the azimuth angle measurement module respectively. The input terminals of both the absolute distance measurement signal processing module and the relative displacement measurement signal processing module are electrically connected to the first photodetector and the second photodetector. An input terminal of the air refractive index calculation module is electrically connected to the environmental monitoring sensor, and an output terminal of the air refractive index calculation module is also connected to the absolute distance measurement signal processing module and the relative displacement measurement signal processing module respectively. Both the absolute distance measurement signal processing module and the relative displacement measurement signal processing module have three input terminals, and the three input terminals are all the first photodetector, the second photodetector, and the air refractive index calculation module.

Output terminals of the absolute distance measurement signal processing module and the relative displacement measurement signal processing module are connected to the distance fusion module. Output terminals of the image processing module, the tracking error signal preprocessing module, the angle decoding module, and the distance fusion module are all simultaneously connected to the tracking control module. An output terminal of the tracking control module is connected to the azimuth torque motor and the pitch torque motor via the motor driver.

The output terminals of the angle decoding module and the distance fusion module are both connected to the synchronization module, and an output terminal of the synchronization module is connected to the computer.

II. A laser tracking interferometric spatial coordinate measurement and control method based on the dual electro-optical frequency comb.

1) The light source module outputs a single-frequency laser traceable to a gas absorption peak. The single-frequency laser is transmitted through polarization-maintaining fiber to the light source modulation module for electro-optical phase modulation to generate the dual electro-optical frequency comb. The dual electro-optical frequency comb is transmitted to the laser tracking interferometric ranging module. The laser tracking interferometric ranging module outputs measurement light transmitted to the beam adjustment module. The beam adjustment module expands and collimates the measurement light, then performs translation and deflection control adjustment, so that the measurement light is incident to the center of the rotating mirror parallel to the gravity direction. After reflection by the rotating mirror, the measurement light is incident on the target mirror of the target mirror assembly of the object under test or the space under test. After reflection by the target mirror of the target mirror assembly, the measurement light returns to the laser tracking interferometric ranging module for real-time receipt to obtain a tracking error signal, a reference interference signal and a measurement interference signal, which are then used to achieve distance measurement and tracking error acquisition.

One path of the dual electro-optical frequency comb serves as measurement light, and another path of the dual electro-optical frequency comb serves as reference light after acousto-optic modulation frequency shifting. Both the reference light and the measurement light are transmitted together to the laser tracking interferometric ranging module via polarization-maintaining fiber.

Then, in the laser tracking interferometric ranging module, the measurement light is combined with the indication light output by the laser diode through the fiber polarization-maintaining combiner. The measurement light and the reference light are respectively expanded and collimated through the first collimator and the second collimator. Both the measurement light and the reference light are divided into a p-polarization state component and an s-polarization state component.

The p-polarized component in the measurement light is transmitted through the first polarizing beamsplitter, then output to the beam adjustment module through the second quarter-wave plate, the right-angle mirror, and the window plate, and returns after being reflected by the rotating mirror and the target mirror. The s-polarized component in the measurement light is reflected by the first polarizing beamsplitter, then returns after being reflected by the first quarter-wave plate, the filter, and the reference corner cube prism. The two returned measurement light beams first undergo transmission and reflection processing through the color separator. The indication light reflected by the color separator is transmitted to the two-dimensional position detector to obtain a tracking error signal for tracking control, and the measurement light transmitted by the color separator is respectively reflected and transmitted at the second polarizing beamsplitter. The s-polarized component of the reference light is reflected by the second polarizing beamsplitter, then combined with the p-polarized component measurement light transmitted through the color separator and input to the first photodetector to obtain the reference interference signal. The p-polarized component of the reference light is transmitted through the second polarizing beamsplitter, then combined with the s-polarized component measurement light reflected by the color separator and input to the second photodetector to obtain the measurement interference signal, and the reference interference signal and the measurement interference signal are used for distance measurement.

2) Controlling the modulation of turning on and off of the light source modulation module, and then measuring and obtaining an absolute distance and a relative displacement through the laser tracking interferometric ranging module in an absolute ranging mode and a relative displacement mode respectively.

In the absolute ranging mode, the light source modulation module is controlled to output the dual electro-optical frequency comb. At this time, the first photodetector and the second photodetector of the laser tracking interferometric ranging module respectively obtain a reference multi-heterodyne interference signal and a measurement multi-heterodyne interference signal. The absolute distance may be obtained through signal processing.

In the relative displacement measurement mode, the light source modulation module is controlled to turn off the electro-optical phase modulation and output dual-frequency continuous laser with a frequency difference of Fa. At this time, the first photodetector and the second photodetector of the laser tracking interferometric ranging module respectively obtain the reference heterodyne interference signal and the measurement heterodyne interference signal, and the relative displacement may be obtained through signal processing.

Meanwhile, air parameter signals are measured through environmental monitoring sensors for air refractive index compensation of the ranging module, and angle measurement signals of the pitch angle and the azimuth angle of the rotating mirror under a tracking condition are obtained in real time through the pitch angle measurement module and the azimuth angle measurement module of the precision optical tracking unit, as well as a frame image of the target mirror assembly under the tracking condition is obtained in real time through the vision module of the precision optical tracking unit.

3) The obtained tracking error signal, reference interference signal, measurement interference signal, air parameter signals, angle measurement signal, image, and absolute distance and relative displacement are all input to the tracking control and signal processing module for processing, controlling the rotation control of the pitch torque motor and the azimuth torque motor to further control the rotation of the rotating mirror, thereby achieving closed-loop tracking of the target mirror of the target mirror assembly, while also converting the synchronized angle information and the distance information into a three-dimensional coordinate for display.

In step 3) for the tracking control and signal processing module:

The air parameter signals, the reference interference signal, the measurement interference signal, and the angle measurement signal are transmitted to the tracking control and signal processing module for processing. The angle measurement signals are transmitted to the angle decoding module for decoding to obtain an angle information. The reference interference signal and the measurement interference signal are transmitted to the signal processing module to be processed and compensated using the air parameter signals to obtain a distance information. The tracking error signal is transmitted to the tracking error signal preprocessing module for processing to obtain a position deviation information between a measurement light spot and a target mirror center, and the image frame is transmitted to the image processing module for processing to obtain an identification information of all target mirrors.

On one aspect, all target mirror identification information, position deviation information, angle information and distance information are transmitted to the tracking control module, processed through a closed-loop control algorithm to obtain a feedback control signal, and transmitted through the motor driver to the pitch torque motor and the azimuth torque motor to control the rotating mirror rotation to achieve closed-loop tracking of the target mirror.

On another aspect, synchronization processing is performed through the synchronization module to eliminate the delay between the angle information and the distance information, and then the synchronized angle information and distance information are transmitted to the computer for conversion to and display of a three-dimensional coordinate, finally measuring the three-dimensional coordinates of all target mirrors.

After the above processing, the disclosure only adopts a single laser tracking interferometric ranging module to realize the functions of absolute ranging and relative displacement measurement while simultaneously realizing the laser tracking error detection function, simplifying an optical system. Moreover, after processing, a vision module that operates in conjunction with the rotating mirror is adopted for multi-target mirror recognition.

In specific implementation, the pitch torque motor control signal, the vision module signal, and the pitch angle/azimuth angle measurement module signal are transmitted to the frame body through the coaxial conductive ring, which may avoid cable entanglement problems during rotation and may allow unlimited rotation.

In a system of the disclosure, multi-target mirror recognition is performed through the vision module to guide the rotating mirror to direct the laser to each target mirror respectively. The laser tracking interferometric ranging module obtains the tracking error of the laser beam deviating from the center of the target mirror for closed-loop tracking control. The light source module outputs the single-frequency laser traceable to the gas absorption peak. By controlling the light source modulation module to turn on or off the electro-optical phase modulation drive signal, the dual electro-optical frequency comb and the dual-frequency continuous laser are output respectively. In the tracking state, the laser tracking interferometric ranging module uses these two light sources to measure the absolute distance and relative displacement of the target mirror respectively, and the real-time distance between the target mirror and the origin is obtained through distance fusion calculation. The azimuth angle and the pitch angle of the target mirror are obtained in real time through the azimuth angle and pitch angle measurement module. Through tracking control and signal processing module and computer for tracking control and three-dimensional coordinate calculation, the three-dimensional coordinates of all target mirrors are finally measured.

The disclosure performs multi-target mirror recognition through the vision module, guiding the rotating mirror to direct the laser toward each target mirror respectively. The laser tracking interferometric ranging module obtains the tracking error of the laser beam deviating from the target mirror center, which are used for closed-loop tracking control. The light source module outputs the single-frequency laser traceable to the gas absorption peak. By controlling the light source modulation module to turn on or off the electro-optical phase modulation drive signal, the dual electro-optical frequency comb and the dual-frequency continuous laser are output respectively. In the tracking state, the laser tracking interferometric ranging module uses these two light sources to measure the absolute distance and the relative displacement of the target mirror respectively, and the real-time distance between the target mirror and the origin is obtained through distance fusion calculation.

The disclosure obtains the pitch angle and azimuth angle of the target mirror in real time through the azimuth angle and pitch angle measurement module. Through tracking control and coordinate calculation by the tracking control and signal processing module and the computer, the three-dimensional coordinates of all target mirrors are finally measured.

The system of the disclosure may be used in scenarios of robot calibration and component measurement.

The beneficial effects of the disclosure are:

(1) The disclosure adopts a single ranging module based on a dual electro-optical frequency comb to achieve both absolute ADM and RDM ranging functions while simultaneously realizing a laser tracking error detection function, which may simplify system structure, reduce cost, and avoid measurement errors introduced by beam splitting and different distance zero points.

(2) The vision module of the disclosure adopts a gear linkage method for field of view control, which may ensure that the target mirror is always in the central area of the field of view, which is beneficial for multi-target mirror recognition and tracking control.

(3) The disclosure adopts a frame body design to integrate related modules, which is beneficial for assembly and debugging, and adopts a coaxial conductive ring to transmit signals, which may avoid cable entanglement problems during rotation and may allow unlimited rotation.

### BRIEF DESCRIPTION OF THE DRAWINGS

FIG. 1 is a schematic diagram of a laser tracking interferometric spatial coordinate measurement system based on a dual electro-optical frequency comb.

FIG. 2 is a schematic diagram of laser tracking interferometric ranging based on a dual electro-optical frequency comb.

FIG. 3 is a block diagram of tracking control and signal processing principles.

In the figures: 1, target mirror assembly; 101, target mirror; 2, environmental parameter monitoring sensor; 3, frame body; 4, rotating mirror; 5, pitch torque motor; 6, gear assembly; 7, vision module; 8, pitch angle measurement module; 9, coaxial conductive ring; 10, azimuth torque motor; 11, azimuth angle measurement module; 12, beam adjustment module; 13, laser tracking interferometric ranging module; 14, light source modulation module; 15, light source module; 16, power supply module; 17, tracking control and signal processing module; 18, computer.

1302, fiber optic flange assembly; 1303, laser diode; 1304, fiber polarization-maintaining combiner; 1305, first collimator; 1306, first polarizing beamsplitter; 1307, reference corner cube prism; 1308, filter; 1309, first quarter-wave plate; 1310, second quarter-wave plate; 1311, window plate; 1313, cable shield interface; 1314, second collimator; 1315, color separator; 1316, second polarizing beamsplitter; 1317, first photodetector; 1318, second photodetector; 1319, two-dimensional position detector; 1320, right-angle mirror; 1321, shielding enclosure.

1701, image processing module; 1702, tracking error signal preprocessing module; 1703, angle decoding module; 1704, absolute distance measurement signal processing module; 1705, air refractive index calculation module; 1706, relative displacement measurement signal processing module; 1707, tracking control module; 1708, motor driver; 1709, synchronization module; 1710, distance fusion module; 1711, signal processing module.

### DESCRIPTION OF THE EMBODIMENTS

The disclosure will be described in detail below with reference to the accompanying drawings and embodiments.

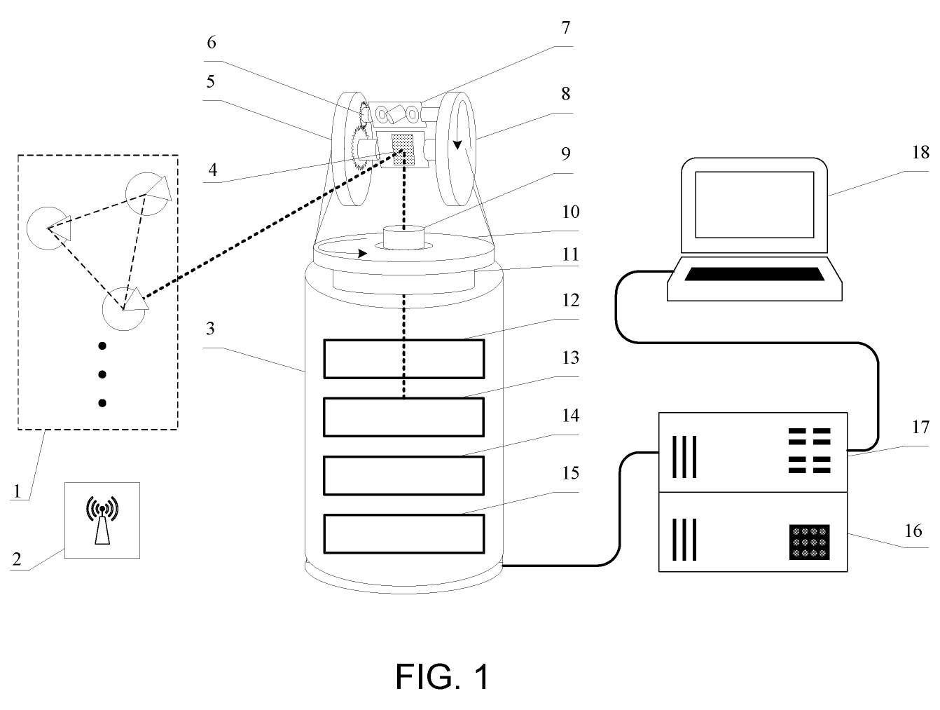

As shown in FIG. 1, a laser tracking interferometric spatial coordinate measurement system based on a dual electro-optical frequency comb specifically includes the following.

The entire apparatus is divided into three parts: a precision optical tracking unit, a ranging unit based on a dual electro-optical frequency comb, and an electrical control unit. A part of the precision optical tracking unit is mounted on a frame body 3, and another part is mounted on the object under test or space under test. The ranging unit is mounted within the frame body 3. The electrical control unit is electrically connected to the precision optical tracking unit and the ranging unit respectively. The electrical control unit controls the ranging unit based on a dual electro-optical frequency comb to emit dual electro-optical frequency comb beams that are reflected and adjusted by the precision optical tracking unit to be incident on the object under test or space under test and then received to perform spatial coordinate measurement of the object under test or space under test.

The precision optical tracking unit mainly includes a target mirror assembly 1, a rotating mirror 4, a pitch torque motor 5, a vision module 7, a pitch angle measurement module 8, an azimuth torque motor 10, and an azimuth angle measurement module 11.

The target mirror assembly 1 includes a plurality of target mirrors 101, and the target mirrors 101 of the target mirror assembly 1 are arranged on the object under test or in the space under test.

The azimuth torque motor 10 is mounted on the upper end of the frame body 3. The rotating end of the azimuth torque motor 10 has a rotating mirror axis and a vision axis mounted through a bracket, both of which are horizontal and parallel to each other. The rotating mirror axis is mounted on the bracket in a manner that allows it to rotate around its own axial direction, and the bracket is fixed to the rotating end of the azimuth torque motor 10. Meanwhile, the rotating end of the azimuth torque motor 10 is provided with an azimuth angle measurement module 11 for detecting the rotation angle. The rotating mirror axis is driven by the azimuth torque motor 10 to rotate horizontally around the vertical axis, while the azimuth angle measurement module 11 measures the angle of horizontal rotation.

The rotating mirror shaft may be independently rotatably mounted on the bracket, with an end of the rotating mirror shaft coaxially and fixedly connected to the rotating end of the pitch torque motor 5, and the other end of the rotating mirror shaft connected to the pitch angle measurement module 8 for measuring the rotation angle of the rotating mirror shaft. The rotating mirror 4 is fixedly mounted on the rotating mirror shaft.

The visual axis may be independently rotatably mounted on the bracket through a gear assembly 6, and the vision module 7 is fixedly mounted on the visual axis.

This arrangement enables the rotating mirror 4 and the vision module 7 to independently perform pitch rotation with the same degree of freedom.

The vision module 7 has a rotation axis parallel to the rotation axis of the rotating mirror 4, and they are linked through the gear assembly 6 with a pitch angle rotation ratio of 2:1. In the tracking state, the target mirror is always within the field of view of the vision module camera. Moreover, infrared laser tubes are designed on both left and right sides of the camera of the vision module 7, which emit radial infrared light toward the target mirror assembly 1 in a time-division manner. The camera is configured to observe the image of the target mirror assembly 1, systematically identify the target mirrors in the image and number the same, thereby guiding the rotating mirror 4 to direct the laser toward each target mirror 101 respectively. When tracking is interrupted, the rotating mirror 4 may be guided to track the target mirrors based on the target mirror identification results, achieving reconnection after interruption.

The ranging unit based on the dual electro-optical frequency comb is the core part of the disclosure, mainly including a beam adjustment module 12, a laser tracking interferometric ranging module 13, a light source modulation module 14, and a light source module 15 that are coaxially arranged sequentially from bottom to top, and these modules are mounted in layers within the frame body 3.

The dual electro-optical frequency comb is generated by the light source module 15 and the light source modulation module 14. The light source module 15 outputs single-frequency laser traceable to gas absorption peaks. The single-frequency laser is transmitted through polarization-maintaining fiber to the light source modulation module 14 for electro-optical phase modulation to generate the dual electro-optical frequency comb. The dual electro-optical frequency comb is transmitted to the laser tracking interferometric ranging module 13. The laser tracking interferometric ranging module 13 outputs measurement light transmitted to the beam adjustment module 12. The beam adjustment module 12 expands and collimates the measurement light, then performs translation and deflection control adjustment, so that the measurement light is incident to the center of the rotating mirror 4 parallel to the gravity direction. After reflection by the rotating mirror 4, the measurement light is incident on the target mirror 101 of the target mirror assembly 1 of the object under test or the space under test, and after reflection by the target mirror 101 of the target mirror assembly 1, the measurement light returns to the laser tracking interferometric ranging module 13, thereby achieving distance measurement and tracking error acquisition.

When the electro-optical phase modulation drive signal in the light source modulation module 14 is turned off, the non-zero order comb teeth of the dual electro-optical frequency comb will disappear, and the dual electro-optical frequency comb becomes dual-frequency continuous laser. One path of the dual electro-optical frequency comb emitted by the light source modulation module 14 serves as measurement light, and the other path of the dual electro-optical frequency comb serves as reference light after acousto-optic modulation frequency shifting. Both the reference light and measurement light are transmitted together to the laser tracking interferometric ranging module 13 via polarization-maintaining fiber.

In the beam adjustment module 12, the measurement light is first expanded and collimated into a circular Gaussian beam with a diameter of 10mm, then adjusted through translation and deflection control adjustment mirrors to make the measurement light parallel to the gravity direction and incident to the origin position of the rotation center of the rotating mirror 4. After reflection by the rotating mirror 4 and target mirror 1322, the measurement light returns to the laser tracking interferometric ranging module 13 to achieve distance measurement and tracking error acquisition.

Electronic components such as the pitch torque motor 5, the vision module 7, the pitch angle measurement module 8, the azimuth torque motor 10, and the azimuth angle measurement module 11 within the precision optical tracking unit are electrically connected to the electrical control unit through wires and a coaxial conductive ring 9 mounted at the upper end of the frame body 3. This enables power supply and signal transmission between the electronic components within the precision optical tracking unit and the frame body 3 through the coaxial conductive ring 9, without requiring cables, which may avoid cable entanglement issues during rotation and allows for unlimited rotation.

Moreover, the azimuth torque motor 10 and the azimuth angle measurement module 11 of the precision optical tracking cell are both annular structures with central through holes, and a coaxial conductive ring 9 with a central through hole is disposed in the annular structure. The beam emitted by the beam adjustment module 12 transmits through the hollow central through holes of the azimuth torque motor 10, the azimuth angle measurement module 11, and the coaxial conductive ring 9 and then is incident on the rotating mirror 4.

The electrical control unit mainly includes a power supply module 16, a tracking control and signal processing module 17, and a computer 18. The tracking control and signal processing module 17 and the computer 18 are electrically connected. The power supply module 16 and the tracking control and signal processing module 17 are connected for power supply. The tracking control and signal processing module 17 is electrically connected to the pitch torque motor 5, the vision module 7, the pitch angle measurement module 8, the azimuth torque motor 10 and the azimuth angle measurement module 11 of the precision optical tracking unit, and to the beam adjustment module 12, the laser tracking interferometric ranging module 13, the light source modulation module 14 and the light source module 15 of the ranging unit respectively.

The system further includes an environmental monitoring sensor 2. The environmental monitoring sensor 2 is electrically connected to the tracking control and signal processing module 17 of the electrical control unit. The environmental monitoring sensor 2 is configured to measure the temperature, humidity and air pressure parameters of the air and transmit them wirelessly to the tracking control and signal processing module 17, for air refractive index compensation in the laser tracking interferometric ranging module 13.

The tracking control and signal processing module 17 of the electrical control unit processes and outputs closed-loop control signals based on the target mirror information in the images obtained by the vision module 7 and the tracking error signals obtained by the laser tracking interferometric ranging module 13, thereby controlling the azimuth torque motor 10 and the pitch torque motor 5 to jointly rotate the rotating mirror 4 to track the target mirror 1; simultaneously, the pitch angle and azimuth angle information of the target target mirror in the tracking state are obtained in real time through the azimuth angle measurement module 11 and the pitch angle measurement module 8, and combined with the distance information obtained by the laser tracking interferometric ranging module 13, synchronous matching of the angle information and the distance information is performed, and error compensation and coordinate conversion are performed through the computer 18, and the three-dimensional coordinates of each target mirror 101 in the target mirror assembly 1 are obtained after processing.

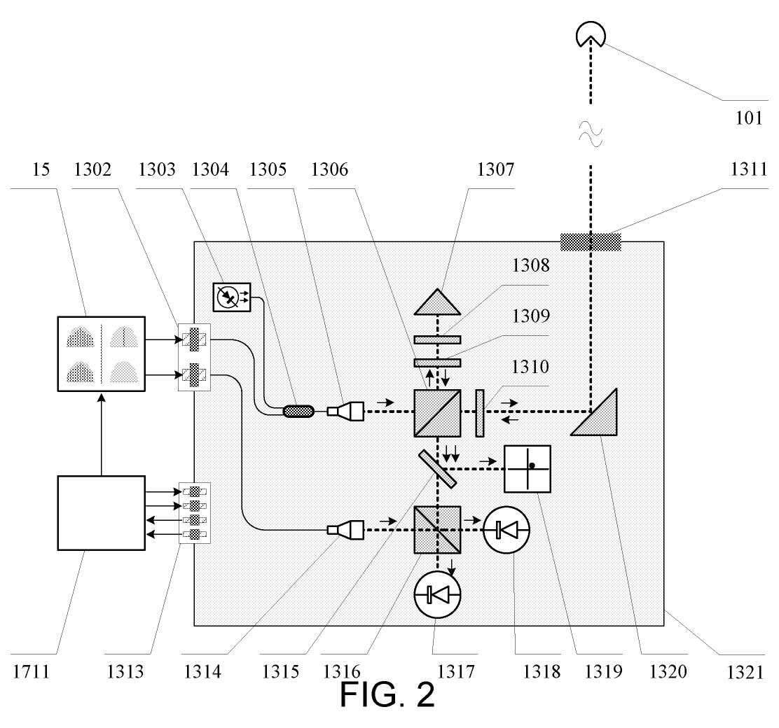

FIG. 2 shows a schematic diagram of laser tracking interferometric ranging based on a dual electro-optical frequency comb, which is a further explanation of the working principle of the laser tracking interferometric ranging module 13 in FIG. 1.

The laser tracking interferometric ranging module 13 adopts a shielding enclosure 1321 for closed packaging, which may isolate air and avoid external interference.

The laser tracking interferometric ranging module 13 includes a laser diode 1303, a fiber polarization-maintaining combiner 1304, a first collimator 1305, a first polarizing beamsplitter 1306, a reference corner cube prism 1307, a filter 1308, a first quarter-wave plate 1309, a second quarter-wave plate 1310, a second collimator 1314, a color separator 1315, a second polarizing beamsplitter 1316, a first photodetector 1317, a second photodetector 1318, a two-dimensional position detector 1319, and a right-angle mirror 1320, all mounted within a shielding enclosure 1321.

The light source modulation module 14 of the ranging unit emits measurement light from the dual electro-optical frequency comb and indication light emitted from the laser diode 1303, which are incident together on the fiber polarization-maintaining combiner 1304 to combine and form a first combined beam. The first combined beam is then expanded and collimated by the first collimator 1305 before being incident on the first polarizing beamsplitter 1306 where it undergoes first transmission and reflection. The first combined beam after the first reflection by the first polarizing beamsplitter 1306 is sequentially reflected by the first quarter-wave plate 1309, the filter 1308, and the reference corner cube prism 1307, then returns along the original path back to the first polarizing beamsplitter 1306 where it undergoes a second transmission. The first combined beam after the first transmission by the first polarizing beamsplitter 1306 is sequentially reflected by the second quarter-wave plate 1310 and the right-angle mirror 1320, then exits through a window plate 1311 on the shielding enclosure 1321 to the beam adjustment module 12. After being adjusted by the beam adjustment module 12, the first combined beam is incident on the target mirror 101 in the target mirror assembly 1, and after being reflected by the target mirror 101 in the target mirror assembly 1, the first combined beam returns along the original path back to the first polarizing beamsplitter 1306 where it undergoes second reflection.

The retroreflected beams that undergo the second reflection and the second transmission at the first polarizing beamsplitter 1306 are combined to form a second combined beam. The second combined beam is then incident on the color separator 1316 where transmission and reflection occur. The beam reflected by the color separator 1316 is incident on and received by the two-dimensional position detector 1319 to obtain a tracking error signal. The beam transmitted by the color separator 1316 is then incident on the second polarizing beamsplitter 1316 where reflection and transmission occur respectively.

The light source modulation module 14 of the ranging unit emits reference light from the dual electro-optical frequency comb, which is incident on the second polarizing beamsplitter 1316 after beam expansion and collimation by the second collimator 1314, where reflection and transmission occur. The beam of reference light reflected by the second polarizing beamsplitter 1316 and the beam of the second combined light transmitted through the second polarizing beamsplitter 1316 are incident together on the first photodetector 1317 to be received and obtain a reference interference signal. The beam of reference light transmitted through the second polarizing beamsplitter 1316 and the beam of the second combined light reflected by the second polarizing beamsplitter 1316 are incident together on the second photodetector 1318 to be received and obtain a measurement interference signal.

In specific implementation, the shielding enclosure 1321 is provided with a fiber optic flange assembly 1302. The measurement light and reference light in the dual electro-optical frequency comb emitted by the light source modulation module 14 of the ranging unit are respectively incident into the shielding enclosure 1321 through different interface channels in the fiber optic flange assembly 1302.

In specific implementation, the two-dimensional position detector 1319, the first photodetector 1317, and the second photodetector 1318 are all electrically connected through a cable shield interface 1313 provided on the shielding enclosure 1321 to the signal processing module 1711 in the tracking control and signal processing module 17 of the electrical control unit, and the signal processing module 1711 in the tracking control and signal processing module 17 of the electrical control unit is further electrically connected to the light source module 15.

Specifically, in the laser tracking interferometric ranging module 13, the measurement light is combined with the indication light output by the laser diode 1303 through the fiber polarization-maintaining combiner 1304. The measurement light and the reference light are respectively expanded and collimated through the first collimator 1305 and the second collimator 1314. Both the measurement light and the reference light are divided into p-polarization state components and s-polarization state components.

Among them, the p-polarized component in the measurement light is transmitted through the first polarizing beamsplitter 1306, then output to the beam adjustment module 12 through the second quarter-wave plate 1310, the right-angle mirror 1320, and the window plate 1311, and returns after being reflected by the rotating mirror 4 and the target mirror 1322. The s-polarized component in the measurement light is reflected by the first polarizing beamsplitter 1306, then returns after being reflected by the first quarter-wave plate 1309, the filter 1308, and the reference corner cube prism 1307. The two returned measurement light beams first undergo transmission and reflection processing at the color separator 1316. The indication light reflected by the color separator 1316 is transmitted to the two-dimensional position detector 1319 to obtain tracking error signals for tracking control, and the measurement light transmitted by the color separator 1316 is respectively reflected and transmitted at the second polarizing beamsplitter 1316. The s-polarized component of the reference light is reflected by the second polarizing beamsplitter 1316, then combined with the p-polarized component measurement light transmitted through the color separator 1316 and input to the first photodetector 1317 to obtain reference interference signals. The p-polarized component of the reference light is transmitted through the second polarizing beamsplitter 1316, then combined with the s-polarized component measurement light reflected by the color separator 1316 and input to the second photodetector 1318 to obtain measurement interference signals, and the reference interference signals and measurement interference signals are used for distance measurement.

Among them, the first photodetector 1317 and the second photodetector 1318 have polarizers integrated internally, and the transmission axis of the polarizers differs by 45° from the p-polarization state of the second polarizing beamsplitter 1316.

The laser tracking interferometric ranging module 13 has both absolute ranging and relative displacement measurement functions, and simultaneously has laser tracking error detection function:

In absolute ranging mode, the light source modulation module 14 is controlled to enable electro-optical phase modulation, outputting the dual electro-optical frequency comb. At this time, the first photodetector 1317 and the second photodetector 1318 of the laser tracking interferometric ranging module 13 respectively obtain reference multi-heterodyne interference signals and measurement multi-heterodyne interference signals. Through signal processing, absolute distance may be obtained.

In the relative displacement measurement mode, the light source modulation module 14 is controlled to turn off electro-optical phase modulation and output dual-frequency continuous laser with a frequency difference of Fₐ. At this time, the first photodetector 1317 and the second photodetector 1318 of the laser tracking interferometric ranging module 13 respectively obtain reference heterodyne interference signals and measurement heterodyne interference signals, and relative displacement may be obtained through signal processing.

The laser tracking error detection function may be performed simultaneously in both ranging modes without mutual interference. Under the laser tracking error detection function, the returned indication light is transmitted to the two-dimensional position detector 1319 to obtain tracking error signals for tracking control.

In the embodiment of the disclosure, compared to the reference light in the dual electro-optical frequency comb, the measurement light has a center frequency higher by Fₐ=100MHz and a repetition frequency higher by 1MHz. The photodetector has a bandwidth of 200MHz, and the filter amplification module has a cutoff frequency of 150MHz. The single-frequency laser wavelength is 780.24nm, and the indication light wavelength is 650nm.

The tracking control and signal processing module 17 includes an image processing module 1701, a tracking error signal preprocessing module 1702, an angle decoding module 1703, a tracking control module 1707, a motor driver 1708, a synchronization module 1709, and a signal processing module 1711. The signal processing module 1711 includes an absolute distance measurement signal processing module 1704, an air refractive index calculation module 1705, a relative displacement measurement signal processing module 1706, and a distance fusion module 1710.

The input terminals of the image processing module 1701, the tracking error signal preprocessing module 1702, and the angle decoding module 1703 are electrically connected to the vision module 7, the two-dimensional position detector 1318, and the azimuth angle measurement module 11, respectively. The input terminals of both the absolute distance measurement signal processing module 1704 and the relative displacement measurement signal processing module 1706 are electrically connected to the first photodetector 1317 and the second photodetector 1318. The input terminal of the air refractive index calculation module 1705 is electrically connected to the environmental monitoring sensor 2, and the output terminal of the air refractive index calculation module 1705 is also connected to the absolute distance measurement signal processing module 1704 and the relative displacement measurement signal processing module 1706, respectively. Both the absolute distance measurement signal processing module 1704 and the relative displacement measurement signal processing module 1706 have three input terminals, with all three input terminals being the first photodetector 1317, the second photodetector 1318, and the air refractive index calculation module 1705.

The output terminals of the absolute distance measurement signal processing module 1704 and the relative displacement measurement signal processing module 1706 are connected to the distance fusion module 1710. The output terminals of the image processing module 1701, the tracking error signal preprocessing module 1702, the angle decoding module 1703, and the distance fusion module 1710 are all simultaneously connected to the tracking control module 1707. The output terminal of the tracking control module 1707 is connected to the azimuth torque motor 10 and the pitch torque motor 5 via the motor driver 1708.

The output terminals of the angle decoding module 1703 and the distance fusion module 1710 are both connected to the synchronization module 1709, and the output terminal of the synchronization module 1709 is connected to the computer 18.

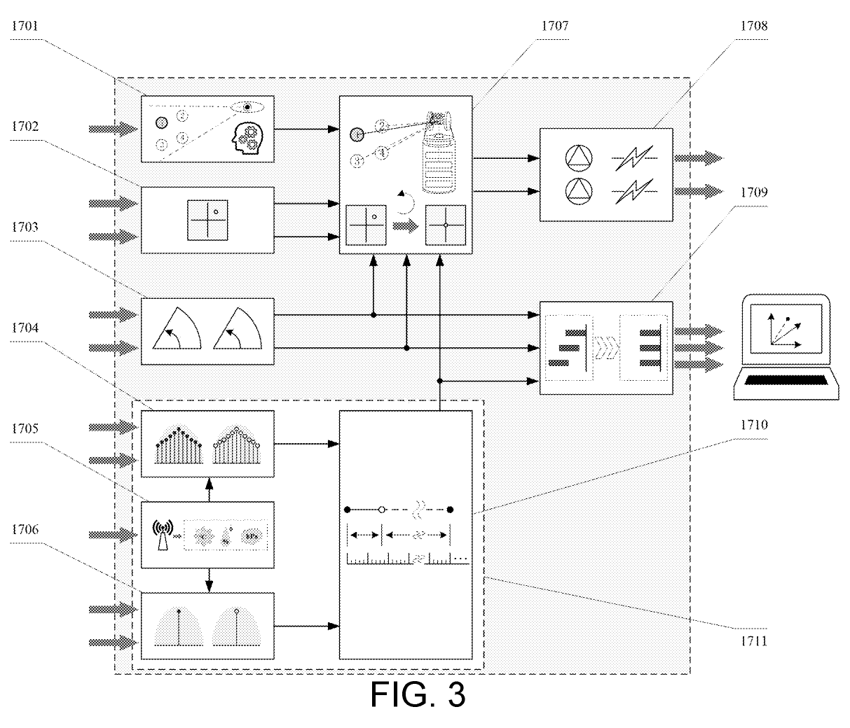

FIG. 3 shows a block diagram of tracking control and signal processing principles, which is a further explanation of the working principle of the tracking control and signal processing module 17 in FIG. 1.

The image processing module 1701 processes the images output by the vision module 7, adopts artificial intelligence algorithms to quickly identify all target mirrors in the scene, and performs sorting and numbering. The tracking error signal preprocessing module 1702 performs filtering and amplification processing on the tracking error signals output by the two-dimensional position detector 1318. The angle decoding module 1703 decodes the angle measurement signals output by the pitch angle measurement module 8 and the azimuth angle measurement module 11, and calculates angle values in real time.

In an ADM absolute ranging mode, the first photodetector 1317 and the second photodetector 1318 together output a pair of multi-heterodyne interference signals. In an RDM relative ranging mode, the first photodetector 1317 and the second photodetector 1318 together output a pair of heterodyne interference signals. The signals from these two modes are processed by the absolute distance measurement signal processing module 1704 and the relative displacement measurement signal processing module 1706 respectively, to obtain absolute distance and relative displacement respectively. The air refractive index calculation module 1705 receives the air temperature, humidity, and atmospheric pressure parameters measured by the environmental monitoring sensor 2 through wireless transmission, calculates the air refractive index, and transmits the parameters to the absolute distance measurement signal processing module 1704 and the relative displacement measurement signal processing module 1706 for air refractive index compensation.

The absolute distance measurement signal processing module 1704 and the relative displacement measurement signal processing module 1706 transmit measurement results to the distance fusion module 1710 to perform absolute distance zero point compensation for the rotation center of the rotating mirror 4 and fusion calculation of absolute distance with real-time displacement, ultimately obtaining the real-time distance value of the target mirror.

The tracking control module 1707 combines the target mirror recognition results output by the image processing module 1701 and the angle information output by the angle decoding module 1703 to preliminarily determine the approximate position of the target mirror, guiding the measurement light to illuminate the target mirror. After the measurement light illuminates the target mirror, the position deviation between the measurement light spot and the center of the target mirror may be detected by the two-dimensional position detector 1319 and processed by the tracking error signal preprocessing module 1702. The tracking control module 1707 adopts a PID (Proportion-Integral-Differential) closed-loop control algorithm to calculate the tracking error signal output by the tracking error signal preprocessing module 1702 to obtain a feedback control signal, which is transmitted through the motor driver 1708 to the azimuth torque motor 10 and the pitch torque motor 5, controlling the rotation of the rotating mirror 4, so that the measurement light illuminates the center position of the target mirror, thereby achieving closed-loop tracking of the target mirror. When the target mirror moves, the measurement light will automatically follow, ensuring that the measurement light always illuminates the center position of the target mirror. The parameters of the PID closed-loop control algorithm are automatically adjusted according to the angle information output by the angle decoding module 1703 and the distance information output by the distance fusion module 1710.

The synchronization module 1709 obtains the pitch angle and the azimuth angle information from the angle decoding module 1703, and obtains the distance information from the distance fusion module 1710, respectively performing buffer processing. Using the signal with the maximum delay as a reference, delay control is performed on the other two signals (taking data corresponding to the delay from the buffered data). The signals after delay control are synchronized in time with the signal having the maximum delay. The synchronized signals are data-packed and sent to the computer for conversion to and display of a three-dimensional coordinate.

In summary, the disclosure adopts a single ranging unit based on a dual electro-optical frequency comb to achieve both absolute ADM and RDM ranging functions while simultaneously realizing laser tracking error detection function, which may simplify system structure, reduce cost and avoid measurement errors introduced by beam splitting. The vision module adopts gear linkage method for field of view control, which may ensure that the target mirror is always in the central area of the field of view, facilitating multi-target mirror recognition and tracking control. The frame body design is adopted to integrate related modules, which is beneficial for assembly and debugging. The coaxial conductive ring is adopted to transmit signals, which may avoid cable entanglement problems during rotation, and may rotate without restriction, and may be widely applicable to the field of laser tracking interferometric ranging technology.

The above specific embodiments are used to explain and illustrate the disclosure, rather than to limit the disclosure. Any modifications and changes made to the disclosure within the spirit of the disclosure and the protection scope of the claims fall within the protection scope of the disclosure.

What is claimed is:

1. A laser tracking interferometric spatial coordinate measurement system based on a dual electro-optical frequency comb, wherein:
the laser tracking interferometric spatial coordinate measurement system is divided into three parts comprising a precision optical tracking unit, a ranging unit based on the dual electro-optical frequency comb, and an electrical control unit; a part of the precision optical tracking unit is mounted on a frame body, and another part is mounted on an object under test or a space under test, wherein the ranging unit is mounted within the frame body, the electrical control unit is electrically connected to the precision optical tracking unit and the ranging unit respectively, and the electrical control unit controls the ranging unit based on the dual electro-optical frequency comb to emit a dual electro-optical frequency comb beam that is reflected and adjusted by the precision optical tracking unit to be incident on the object under test or the space under test and then received to perform spatial coordinate measurement of the object under test or the space under test.

2. The laser tracking interferometric spatial coordinate measurement system based on the dual electro-optical frequency comb according to claim 1, wherein: the precision optical tracking unit mainly comprises a target mirror assembly, a rotating mirror, a pitch torque motor, a vision module, a pitch angle measurement module, an azimuth torque motor, and an azimuth angle measurement module; the target mirror assembly is arranged on the object under test or in the space under test; the azimuth torque motor is mounted on an upper end of the frame body, a rotating end of the azimuth torque motor has a rotating mirror shaft and a vision shaft parallel to each other horizontally mounted through a bracket, and the rotating end of the azimuth torque motor is provided with the azimuth angle measurement module for detecting a rotation angle; an end of the rotating mirror shaft is coaxially and fixedly connected to a rotating end of the pitch torque motor, another end of the rotating mirror shaft is connected to the pitch angle measurement module for measuring the rotation angle of the rotating mirror shaft, and the rotating mirror is fixedly mounted on the rotating mirror shaft; the vision shaft is rotatably mounted on the bracket through a gear assembly, and the vision module is fixedly mounted on the vision shaft.

3. The laser tracking interferometric spatial coordinate measurement system based on the dual electro-optical frequency comb according to claim 1, wherein: the ranging unit based on the dual electro-optical frequency comb comprises a beam adjustment module, a laser tracking interferometric ranging module, a light source modulation module, and a light source module arranged sequentially from a bottom to a top;
the light source module outputs a single-frequency laser traceable to a gas absorption peak, the single-frequency laser is transmitted through a polarization-maintaining fiber to the light source modulation module for electro-optical phase modulation to generate the dual electro-optical frequency comb, the dual electro-optical frequency comb is transmitted to the laser tracking interferometric ranging module, the laser tracking interferometric ranging module outputs a measurement light transmitted to the beam adjustment module, the beam adjustment module expands and collimates the measurement light and then performs translation and deflection control adjustment to make the measurement light incident to a center of a rotating mirror, wherein after being reflected by the rotating mirror, the measurement light is incident on the target mirror assembly of the object under test or the space under test, and returns to the laser tracking interferometric ranging module after being reflected by the target mirror assembly.

4. The laser tracking interferometric spatial coordinate measurement system based on the dual electro-optical frequency comb according to claim 1, wherein: a pitch torque motor, a vision module, a pitch angle measurement module, an azimuth torque motor and an azimuth angle measurement module within the precision optical tracking unit are electrically connected through a wire and a coaxial conductive ring disposed at an upper end of the frame body.

5. The laser tracking interferometric spatial coordinate measurement system based on the dual electro-optical frequency comb according to claim 1, wherein: the electrical control unit mainly comprises a power supply module, a tracking control and signal processing module and a computer, wherein the tracking control and signal processing module and the computer are electrically connected, the power supply module and the tracking control and signal processing module are connected for power supply, the tracking control and signal processing module is electrically connected to the precision optical tracking unit and the ranging unit respectively; and
the laser tracking interferometric spatial coordinate measurement system further comprises an environmental monitoring sensor, the environmental monitoring sensor is electrically connected to the tracking control and signal processing module of the electrical control unit, the environmental monitoring sensor is for measuring a temperature parameter, a humidity parameter and an air pressure parameter of air and transmitting the same wirelessly to the tracking control and signal processing module.

6. The laser tracking interferometric spatial coordinate measurement system based on the dual electro-optical frequency comb according to claim 1, wherein: a tracking control and signal processing module of the electrical control unit processes and outputs a closed-loop control signal according to a target mirror information in an image obtained by a vision module and a tracking error signal obtained by a laser tracking interferometric ranging module, thereby controlling an azimuth torque motor and a pitch torque motor to jointly rotate a rotating mirror to track a target mirror; simultaneously, an azimuth angle measurement module and a pitch angle measurement module acquire an angle information of a pitch angle and an azimuth angle of the target mirror in real-time under a tracking condition, wherein combining with a distance information obtained by the laser tracking interferometric ranging module, synchronous matching of the angle information and the distance information is performed, and after processing by a computer, a three-dimensional coordinate of each target mirror in the target mirror assembly is obtained.

7. The laser tracking interferometric spatial coordinate measurement system based on the dual electro-optical frequency comb according to claim 1, wherein: the laser tracking interferometric ranging module comprises a laser diode, a fiber polarization-maintaining combiner, a first collimator, a first polarizing beamsplitter, a reference corner cube prism, a filter, a first quarter-wave plate, a second quarter-wave plate, a second collimator, a color separator, a second polarizing beamsplitter, a first photodetector, a second photodetector, a two-dimensional position detector, and a right-angle mirror mounted in a shielding enclosure; the ranging unit emits a measurement light from the dual electro-optical frequency comb and incidents to the fiber polarization-maintaining combiner together with an indication light emitted by the laser diode to for light combination, forming a first combined beam, and the first combined beam is then expanded and collimated by the first collimator and then incident to the first polarizing beamsplitter to undergo a first transmission and a first reflection; the first combined beam after the first reflection by the first polarizing beamsplitter sequentially passes through the first quarter-wave plate and the filter and is reflected by the reference corner cube prism, then returns along an original path in reverse to the first polarizing beamsplitter to undergo a second transmission; the first combined beam after the first transmission by the first polarizing beamsplitter sequentially passes through the second quarter-wave plate, is reflected by the right-angle mirror, then exits through a window plate on the shielding enclosure to a beam adjustment module, wherein after being adjusted by the beam adjustment module, the first combined beam is incident to the target mirror assembly, and after being reflected by the target mirror assembly, the first combined beam returns along the original path in reverse to the first polarizing beamsplitter to undergo a second reflection; wherein
light beams retroreflected back to the first polarizing beamsplitter and undergo the second reflection and the second transmission are combined to form a second combined beam, the second combined beam is then incident on the color separator where transmission and reflection occur, a beam reflected by the color separator is incident on the two-dimensional position detector and received to obtain a tracking error signal, a beam transmitted by the color separator is then incident on the second polarizing beamsplitter where reflection and transmission occur respectively, a reference light from the dual electro-optical frequency comb emitted by the ranging unit undergoes beam expansion and collimation through the second collimator and is then incident on the second polarizing beamsplitter where reflection and transmission occur, a beam of the reference light reflected by the second polarizing beamsplitter and a beam of the second combined beam transmitted by the second polarizing beamsplitter are incident together on the first photodetector and received to obtain a reference interference signal, the beam of the reference light transmitted by the second polarizing beamsplitter and the beam of the second combined beam reflected by the second polarizing beamsplitter are incident together on the second photodetector and received to obtain a measurement interference signal.

8. The laser tracking interferometric spatial coordinate measurement system based on the dual electro-optical frequency comb according to claim 1, wherein:
a tracking control and signal processing module comprises an image processing module, a tracking error signal preprocessing module, an angle decoding module, a tracking control module, a motor driver, a synchronization module and a signal processing module, and the signal processing module comprises an absolute distance measurement signal processing module, an air refractive index calculation module, a relative displacement measurement signal processing module and a distance fusion module;
input terminals of the image processing module, the tracking error signal preprocessing module and the angle decoding module are electrically connected to a vision module, a two-dimensional position detector, and an azimuth angle measurement module respectively, input terminals of both the absolute distance measurement signal processing module and the relative displacement measurement signal processing module are electrically connected to a first photodetector and a second photodetector, an input terminal of the air refractive index calculation module is electrically connected to an environmental monitoring sensor, and an output terminal of the air refractive index calculation module is also connected to the absolute distance measurement signal processing module and the relative displacement measurement signal processing module respectively;
output terminals of the absolute distance measurement signal processing module and the relative displacement measurement signal processing module are connected to a distance fusion module, output terminals of the image processing module, the tracking error signal preprocessing module, the angle decoding module and the distance fusion module are all simultaneously connected to the tracking control module, and an output terminal of the tracking control module is connected to an azimuth torque motor and a pitch torque motor via the motor driver;
the output terminals of the angle decoding module and the distance fusion module are both connected to the synchronization module, and an output terminal of the synchronization module is connected to a computer.

9. A laser tracking interferometric spatial coordinate measurement and control method based on a dual electro-optical frequency comb for the laser tracking interferometric spatial coordinate measurement system according to claim 1, comprising:
1) a light source module outputting a single-frequency laser traceable to a gas absorption peak, wherein the single-frequency laser is transmitted through a polarization-maintaining fiber to a light source modulation module for electro-optical phase modulation to generate the dual electro-optical frequency comb, the dual electro-optical frequency comb is transmitted to a laser tracking interferometric ranging module, the laser tracking interferometric ranging module outputs a measurement light transmitted to a beam adjustment module, the beam adjustment module expands and collimates the measurement light and then performs translation and deflection control adjustment to make the measurement light incident to a center of a rotating mirror, wherein after being reflected by the rotating mirror, the measurement light is incident on the target mirror assembly of the object under test or the space under test, and returns to the laser tracking interferometric ranging module after being reflected by the target mirror assembly for real-time receipt of a tracking error signal, a reference interference signal and a measurement interference signal;
2) controlling a modulation of turning on and off of the light source modulation module, and then measuring and obtaining an absolute distance and a relative displacement through the laser tracking interferometric ranging module in an absolute ranging mode and a relative displacement mode respectively;meanwhile measuring air parameter signals through an environmental monitoring sensor, obtaining an angle measurement signal of a pitch angle and an azimuth angle of the rotating mirror in real time through a pitch angle measurement module and an azimuth angle measurement module, and obtaining an image frame of the target mirror assembly in real time through a vision module;
3) inputting the obtained tracking error signal, the reference interference signal, the measurement interference signal, the air parameter signals, the angle measurement signal, the image frame, the absolute distance and the relative displacement to a tracking control and signal processing module for processing, and controlling a rotation control of a pitch torque motor and an azimuth torque motor to further control a rotation of the rotating mirror, achieving closed-loop tracking of the target mirror assembly, while also converting a synchronized angle information and a distance information into a three-dimensional coordinate for display.

10. The laser tracking interferometric spatial coordinate measurement and control method based on the dual electro-optical frequency comb according to claim 9, wherein: in a step 3), in the tracking control and signal processing module, the air parameter signals, the reference interference signal, the measurement interference signal, and the angle measurement signal are transmitted to the tracking control and signal processing module for processing, wherein the angle measurement signal is transmitted to an angle decoding module for decoding to obtain the angle information, the reference interference signal and the measurement interference signal are transmitted to a signal processing module for processing and compensation using the air parameter signals to obtain the distance information, the tracking error signal is transmitted to a tracking error signal preprocessing module for processing a position deviation information between the measurement light spot and a center of a target mirror, and the image frame is transmitted to the image processing module for processing to obtain an identification information of all target mirrors;
on one aspect, the identification information, the position deviation information, the angle information and the distance information of all target mirrors are transmitted to a tracking control module, processed through a closed-loop control algorithm to obtain a feedback control signal, and transmitted through a motor driver to the pitch torque motor and the azimuth torque motor to control the rotating mirror to rotate, thereby achieving closed-loop tracking of the target mirror;
on another aspect, synchronization processing is performed by a synchronization module to eliminate a delay between the angle information and the distance information, and then the synchronized angle information and the distance information are transmitted to a computer for conversion to and display of a three-dimensional coordinate.
